(19) United States
(12) Patent Application Publication
(10) Pub. No.: US 2007/0284059 A1
(43) Pub. Date: Dec. 13, 2007

(54) Vertical blind structure with an easy change of curtain cloth

(76) Inventor: Chin-Fu Chen, Taichung City (TW)

Correspondence Address: BIRCH STEWART KOLASCH & BIRCH, PO BOX 747, FALLS CHURCH, VA, 22040-0747, US

(21) Appl. No.: 11/448,014

(22) Filed: Jun. 7, 2006

(51) Int. Cl. E06B 9/36

(52) U.S. Cl. 160/168.1 V

(57) ABSTRACT

A vertical blind structure with an easy change of curtain cloth includes a sliding means, a support rack, a connecting portion, and a curtain cloth. The sliding means includes a fixed member fixed at a predetermined position of the vertical blind and a sliding member is moved horizontally along the fixed member. The support rack is installed on the sliding member, and the connecting portion is disposed on the support rack and has an adhering element. The adhering element is adhered to an adhering structure at an end of the curtain cloth and can be removed and adhered repeatedly, such that the adhering element and the adhering structure can be adhered repeatedly to provide a vertical blind structure with an easy change of curtain cloth and facilitate the cleaning and maintenance of the curtain cloth.

### FIELD OF THE INVENTION

The present invention relates to a vertical blind, and more particularly to a vertical blind structure with an easy change of curtain cloth.

### BACKGROUND OF THE INVENTION

Various different shade structures such as Venetian blinds, vertical blinds and curtains are installed to windows for shading the sunlight and protect the privacy of individuals. Referring to FIG. 1 for the schematic view of a prior art vertical blind 1 installed at a French window, the vertical blinds 1 are usually used for French windows to provide a simple and neat appearance and thus vertical blinds 1 are used extensively by consumers.

In general, an end of the curtain cloth 2 of the vertical blind 1 is fixed at a movable suspending means 3 and the other end is drooped to cover a French window 4, so that users can move the suspending means 3 to change the position of the curtain cloth 2 (as shown in FIG. 2) to select whether or not to allow the light to be projected into a room or a house from the outside, so as to shade the sunlight and protect the privacy of individuals. However, most structures of such traditional fixed curtain cloth 2 have not taken the change and maintenance of the curtain cloth 2 into consideration, and thus making the change and maintenance of the curtain cloth 2 difficult and causing tremendous inconvenience to users. Obviously, these structures cannot meet user's requirements.

### SUMMARY OF THE INVENTION

The primary objective of the present invention is to provide a vertical blind structure with an easy change of curtain cloth to facilitate the maintenance of a vertical blind.

The present invention provides a vertical blind structure comprising a sliding means, a support rack, a connecting portion and a curtain cloth. The sliding means includes a fixed member and a sliding member, and the sliding member can be moved horizontally with respect to the fixed member, and the support rack is fixed to the sliding member, so as to move the sliding means horizontally by the sliding member. The connecting portion is disposed on the support rack, and the connecting portion includes an adhering element, and an end of the curtain cloth includes an adhering structure, and the adhering element is adhered to the adhering structure. Therefore, the adhering element can be removed from the adhering structure and adhered repeatedly.

Users can repeatedly adhere the adhering element to the adhering structure to remove the curtain cloth easily for maintenance and cleaning. After the maintenance or cleaning, the curtain cloth is reinstalled, and thus users can maintain the curtain cloth easily.

### BRIEF DESCRIPTION OF THE DRAWINGS

FIG. 1 is a schematic view of a prior art vertical blind installed to a French window;

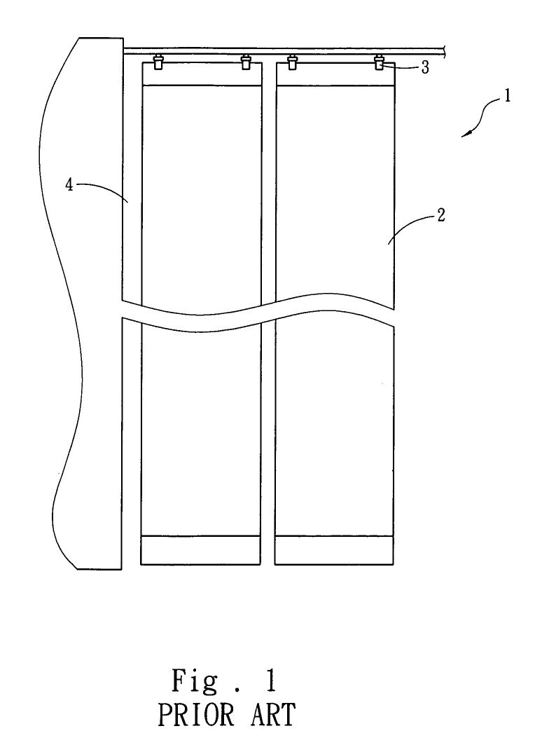

FIG. 2 is a schematic view of the displacement of a prior art vertical blind;

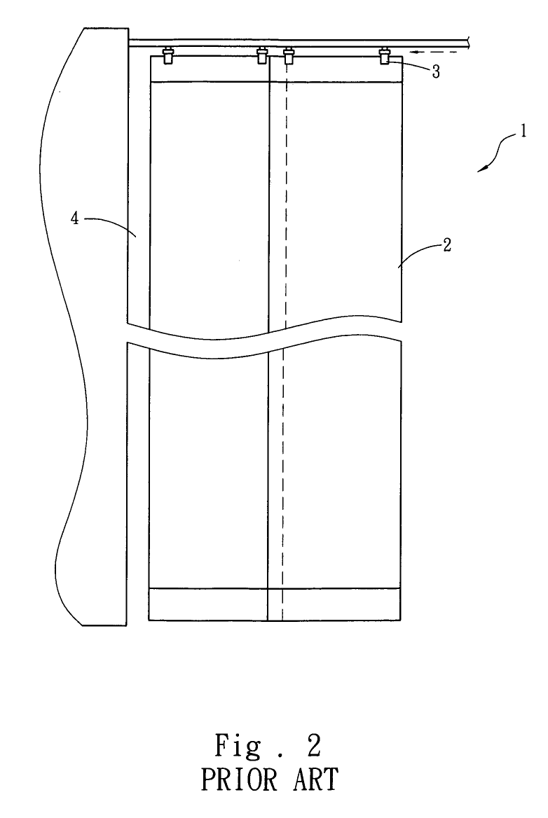

FIG. 3 is an exploded view of a structure of the invention;

FIG. 4 is another exploded view of a structure of the invention; and

FIG. 5 is a side view of a structure connecting a connecting portion and a curtain cloth according to the invention.

### DETAILED DESCRIPTION OF THE PREFERRED EMBODIMENTS

To make it easier for our examiner to understand the objective of the invention, its structure, innovative features, and performance, we use a preferred embodiment together with the attached drawings for the detailed description of the invention.

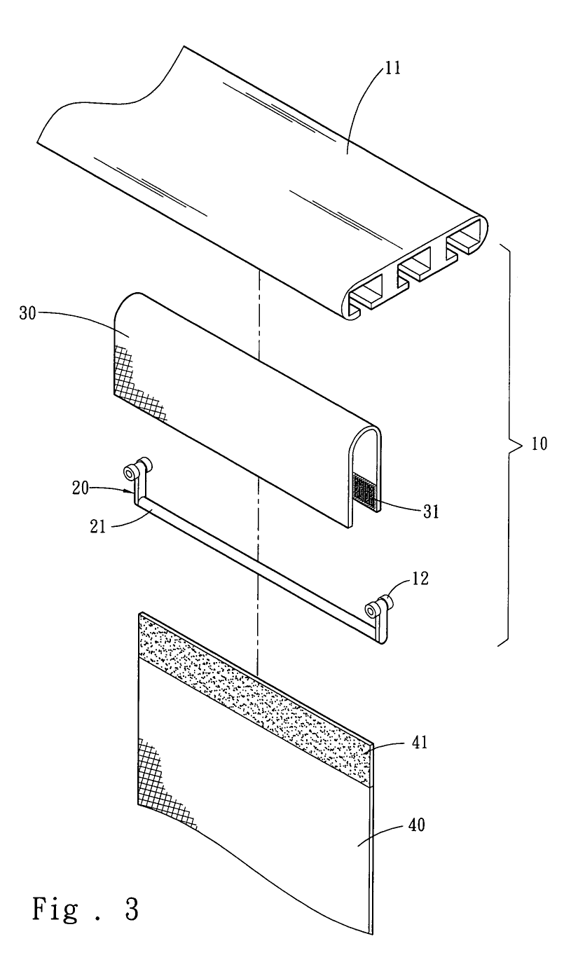

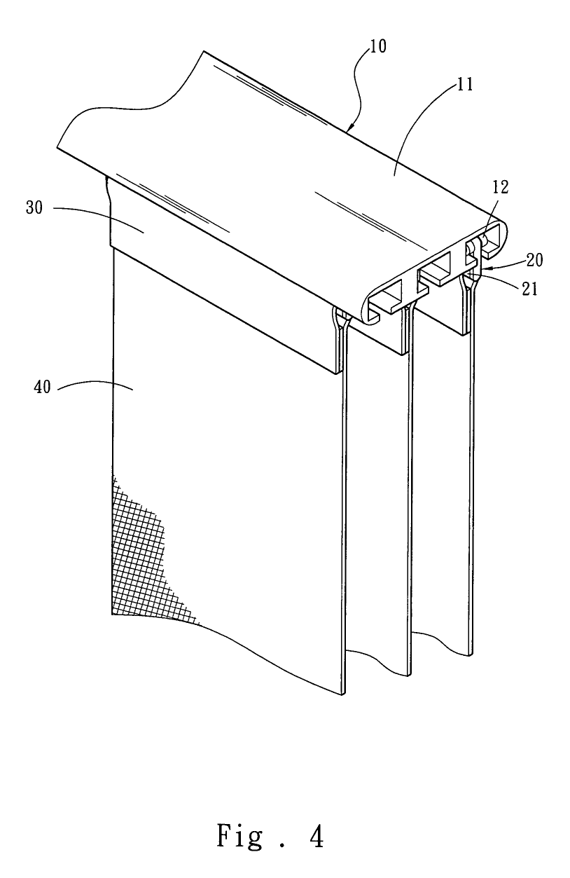

Referring to FIGS. 3 and 4 for a vertical blind structure of the invention, the vertical blind structure comprises a sliding means 10, a support rack 20, a connecting portion 30 and a curtain cloth 40. The sliding means 10 includes a fixed member 11 and a sliding member 12, and the sliding member 12 can be moved horizontally with respect to the fixed member 11, and the support rack 20 is fixed to the sliding member 12 and can be moved horizontally by the sliding member 12. The connecting portion 30 is disposed on the support rack 20, and the connecting portion 30 includes an adhering element 31, and an end of the curtain cloth 40 includes an adhering structure 41, and the adhering element 31 is adhered to the adhering structure 41, and the adhering element 31 can be removed from the adhering structure 41 and adhered repeatedly.

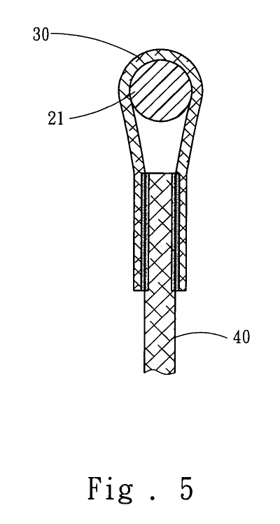

The fixed member 11 and the sliding member 12 of the sliding means 10 of the invention are a sliding track and a roller respectively. With the sliding track and roller, the sliding member 12 can be moved horizontally with respect to the fixed member 11. Further, the support rack 20 includes a transversal rod 21, and the connecting portion 30 is disposed transversally on the transversal rod 21, and the adhering element 31 is extended downwardly from both sides of the transversal rod 21, and both sides of an end of the curtain cloth 40 have the adhering structure 41 for adhering the adhering element 31 with the adhering structure 41 separately on both sides of an end of the curtain cloth 40 (as shown in FIG. 5) to enhance the connecting strength of the curtain cloth 40 and the support rack 20. Further, the external surface of the transversal rod 21 is smooth and slippery, and thus it can prevent the connecting portion 30 from breaking due to the friction with the support rack 20. The adhering element 31 of the connecting portion 30 and the adhering structure 41 of the curtain cloth 40 are adhesive tapes, and the feature of the repeated adhesions of the adhesive tape allows the adhering element 31 to be removed from the adhering structure 41 and adhered repeatedly.

In summation of the description above, the present invention provides a way of removing the curtain cloth 40 from the connecting portion 30 by the feature of repeatedly adhering the curtain cloth 40 by the adhering structure 41 and the adhering element 31 of the connecting portion 30 and adhering them again after the curtain cloth 40 is cleaned or maintained. Therefore, the present invention provides a vertical blind structure with an easy change of curtain cloth 40 that allows users to maintain the curtain cloth 40 easily.

What is claimed is:

1. A vertical blind structure with an easy change of curtain cloth, comprising:
a sliding means, including a fixed member and a sliding member, and said sliding member being moved horizontally with respect to said fixed member;
a support rack, coupled to said sliding member for moving said sliding member horizontally;
a connecting portion, disposed on said support rack and having an adhering element; and
a curtain cloth, having an adhering structure disposed at an end of said curtain cloth and said adhering element being adhered with said adhering structure, and said adhering element being removable from said adhering structure and adhered repeatedly.

2. The vertical blind structure of claim 1, wherein said fixed member and said sliding member of said sliding means are a sliding track and a roller respectively.

3. The vertical blind structure of claim 1, wherein said support rack includes a transversal rod, and said connecting portion is disposed transversally on said transversal rod, and said adhering element is extended downwardly from both sides of said transversal rod, and both sides of an end of said curtain cloth separately install said adhering structure.

4. The vertical blind structure of claim 3, wherein said transversal rod has a smooth and slippery external surface.

5. The vertical blind structure of claim 3, wherein said adhering element of said connecting portion and said adhering structure of said curtain cloth are adhesive tapes.

6. The vertical blind structure of claim 1, wherein said adhering element of said connecting portion and said adhering structure of said curtain cloth are adhesive tapes.
